(19) United States
(12) Patent Application Publication
(10) Pub. No.: US 2024/0290934 A1
(43) Pub. Date: Aug. 29, 2024

(54) Secondary Battery Electrode Slurry Coating Device, and Electrode Slurry Coating Method Using Same

(71) Applicant: LG Energy Solution, Ltd., Seoul (KR)

(72) Inventors: Jae Pil Koo, Daejeon (KR); Jae Huoung Son, Daejeon (KR); Chang Bum Ahn, Daejeon (KR); Jae Wook Lee, Daejeon (KR)

(73) Assignee: LG Energy Solution, Ltd., Seoul (KR)

(21) Appl. No.: 18/022,331

(22) PCT Filed: Aug. 24, 2022
(86) PCT No.: PCT/KR2022/012650

§ 371 Date: Feb. 21, 2023

(30) Foreign Application Priority Data
Aug. 27, 2021 (KR) 10-2021-0113571

(51) Int. Cl. H01M 4/04

(52) U.S. Cl. CPC H01M 4/0404

(57) ABSTRACT

A device for coating an electrode slurry for a secondary battery and a method of coating an electrode slurry, which include a slurry transfer pipe with a dual structure including first and second pipes so that a temperature of the electrode slurry temperature can be kept constant when the electrode slurry stored in a slurry tank is transferred to a slot die. Accordingly, the electrode slurry is uniformly applied to a current collector so that a defective rate in electrode manufacturing can be reduced.

### CROSS-REFERENCE TO RELATED APPLICATIONS

The present application is a national phase entry under 35 U.S.C. § 371 of the International Application No. PCT/KR2022/012650 filed on Aug. 24, 2022, which claims priority from Korean Patent Application No. 10-2021-0113571 filed Aug. 27, 2021, all of which are incorporated herein by reference in their entireties.

### FIELD OF THE INVENTION

The present invention relates to a device for coating an electrode slurry for a secondary battery and a method of coating an electrode slurry using the same.

### BACKGROUND OF THE INVENTION

As technology development and demand for mobiles devices increase, the demands for secondary batteries as energy sources are rapidly increasing, and among these secondary batteries, a lot of research has been made on lithium secondary batteries with a high energy density and a high discharge voltage and the lithium secondary batteries have been commercialized and widely used.

Types of secondary batteries currently widely used include lithium ion batteries, lithium polymer batteries, nickel cadmium batteries, nickel hydrogen batteries, nickel zinc batteries, and the like. Such a unit battery cell, that is, an operating voltage of the unit battery cell ranges from about 2.5 V to 4.2 V. Accordingly, when an output voltage that is higher than the above range is required, a plurality of battery cells may be connected in series to form a battery pack. Alternatively, a plurality of battery cells may be connected in parallel to form a battery pack according to a charge/discharge capacity required for the battery pack. Accordingly, the number of battery cells included in the battery pack may be variously set according to a required output voltage or a charge/discharge capacity.

A battery cell as such a secondary battery, in particular, a battery cell as a lithium secondary battery, is generally formed in a structure in which an electrode assembly including a positive electrode containing a lithium transition metal oxide as an electrode active material, a negative electrode containing a carbon-based active material, and a separator is impregnated with a lithium electrolyte.

The electrode of the battery cell is generally manufactured by applying an electrode slurry on a metal foil. The electrode slurry is prepared by mixing an organic solvent with an electrode mixture consisting of an electrode active material, a conductive material, and a binder for adhering to the electrode foil. Here, a lithium cobalt-based oxide, a lithium manganese-based oxide, a lithium nickel-based oxide, and a lithium composite oxide are mainly used as a positive active material, and a carbon-based material is mainly used as a negative active material.

In addition, the electrode of the battery cell is generally formed such that an active material, a conductive material, and a binder are dispersed in a solvent to prepare a slurry and then the slurry is directly applied to a current collector or is applied on an upper portion of a separate support and then a film peeled from the support is laminated on the current collector. Thereafter, the electrode is wound in a roll shape, and then the residual solvent and residual moisture are removed through an electrode drying device.

In this case, in the process of applying the slurry, when a temperature of the slurry is high, the applied slurry is densely applied in a central portion, and when the temperature of the slurry is low, the applied slurry is densely applied to both sides. Therefore, an amount of the slurry applied to the current collector, that is, a height of the applied slurry, becomes non-uniform according to the temperature of the slurry such that there is a problem in that the electrode having a non-uniform rolling rate and a non-uniform rolling density is manufactured.

### BRIEF SUMMARY OF THE INVENTION

An object of the present invention is to provide a device for coating an electrode slurry, which can keep a temperature of an electrode slurry constant in a process of applying a slurry, and a method of coating an electrode slurry using the same.

The present invention relates to a device for coating an electrode slurry. In one embodiment of the present invention, there is provided a device for coating an electrode slurry, which includes a slurry tank configured to store an electrode slurry, a slot die configured to discharge the electrode slurry stored in the slurry tank to a current collector, and a slurry transfer pipe configured to transfer the electrode slurry stored in the slurry tank to a slot die. The slurry transfer pipe may have a vacuum double pipe structure including a first pipe fluidly connected to the slurry tank and the slot die, and a second pipe provided to be spaced apart from an outer wall of the first pipe by a predetermined interval and configured to form a vacuum space between the first pipe and the second pipe.

In another embodiment of the present invention, there is provided a method of coating an electrode slurry using the above-described device for coating an electrode slurry. The method of coating an electrode slurry according to the present invention may include discharging the electrode slurry to the current collector moving in a coating direction (MD) through the slot die and applying the electrode slurry to the current collector, and drying the electrode slurry applied to the current collector. In the applying of the electrode slurry, when heights of the electrode slurry applied to the current collector correspond to a central portion and a peripheral portion on both sides of the central portion based on a width direction (TD), a difference in thickness between the central portion and the peripheral portion may be less than or equal to 5%.

In accordance with the present invention, a device for coating an electrode slurry for a secondary battery and a method of coating an electrode slurry for a secondary battery includes a slurry transfer pipe with a dual structure including first and second pipes so that a temperature of the electrode slurry temperature can be kept constant when the electrode slurry stored in a slurry tank is transferred to a slot die.

Accordingly, the electrode slurry is uniformly applied to a current collector so that a defective rate in electrode manufacturing can be reduced.

### BRIEF DESCRIPTION OF THE DRAWINGS

FIG. 1 is a schematic diagram illustrating a device for coating an electrode slurry for a secondary battery, which includes a slurry transfer pipe, according to the present invention.

FIG. 2 is a cross-sectional view illustrating the slurry transfer pipe.

FIG. 3 is a schematic diagram illustrating a device for coating an electrode slurry for a secondary battery, which includes a slurry transfer pipe, according to the present invention.

FIG. 4 is a cross-sectional view illustrating the slurry transfer pipe.

FIG. 5 is a schematic diagram illustrating a device for coating an electrode slurry for a secondary battery, which includes a slurry transfer pipe, according to the present invention.

FIG. 6 is a partial perspective view illustrating the slurry transfer pipe.

FIG. 7 is a flow chart illustrating a method of coating an electrode slurry.

### DETAILED DESCRIPTION

The present invention relates to a device for coating an electrode slurry. In one embodiment of the present invention, there is provided a device for coating an electrode slurry, which includes a slurry tank configured to store an electrode slurry, a slot die configured to discharge the electrode slurry stored in the slurry tank to a current collector, and a slurry transfer pipe configured to transfer the electrode slurry stored in the slurry tank to a slot die. In this case, the slurry transfer pipe has a vacuum double pipe structure including a first pipe fluidly connected to the slurry tank and the slot die, and a second pipe provided to be spaced apart from an outer wall of the first pipe by a predetermined interval and configured to form a vacuum space between the first pipe and the second pipe.

In another example, the slurry transfer pipe may further include an insulation member which surrounds an outer circumferential surface of the first pipe.

In still another example, the slurry transfer pipe may include a third pipe positioned between the first pipe and the second pipe and configured to surround the first pipe, and the slurry transfer pipe may have a structure in which a fluid is introduced between the first pipe and the third pipe.

In a specific example, the slurry transfer pipe may further include a fluid supply part fluidly connected to the third pipe and configured to supply a fluid between the first pipe and the third pipe, and a temperature controller configured to control a temperature of the fluid supplied between the first pipe and the third pipe.

In addition, the temperature controller may control the temperature of the fluid introduced between the first pipe and the third pipe in the range of 20° C. to 30° C.

In addition, the slot die may further include a temperature sensor configured to measure the temperature of the slurry which is transferred into the slot die or discharged from the slot die.

Meanwhile, in the slurry transfer pipe, the second pipe may have a structure in which an openable/closable air entrance opening is formed on one side of the second pipe.

In addition, the device for coating an electrode slurry according to the present invention may further include a coating roll configured to support and transfer the current collector, and a drying chamber configured to dry the electrode slurry discharged to the current collector.

Furthermore, the slurry transfer pipe may further include a feed pump configured to supply the electrode slurry stored in the slurry tank to the slot die.

In addition, the present invention provides a method of coating an electrode slurry using the above-described device for coating an electrode slurry. In one example, the method of coating an electrode slurry according to the present invention includes discharging the electrode slurry to the current collector moving in a coating direction MD through the slot die and applying the electrode slurry to the current collector, and drying the electrode slurry applied to the current collector. In this case, in the applying of the electrode slurry, when heights of the electrode slurry applied to the current collector correspond to a central portion and a peripheral portion on both sides of the central portion based on a width direction TD, a difference in thickness between the central portion and the peripheral portion may be less than or equal to 5%.

In addition, the applying of the electrode slurry includes transferring the electrode slurry stored in the slurry tank to the slot die through the slurry transfer pipe. Meanwhile, in the transferring of the electrode slurry to the slot die, a temperature of the electrode slurry may be controlled in the range of 20° C. to 30° C.

The present invention may be modified into various forms and may have a variety of embodiments, and therefore, specific embodiments will be described in detail.

However, the embodiments are not to be taken in a sense which limits the present invention to the specific embodiments and should be construed to include all modifications, equivalents, or substituents falling within the spirit and technical scope of the present invention.

In the present invention, the terms “comprising,” “having,” and the like are used to specify the presence of a feature, a number, a step, an operation, a component, an element, or a combination thereof described herein, and they do not preclude the presence or addition of one or more other features, numbers, steps, operations, components, elements, or combinations thereof.

In addition, in the present invention, when a portion of a layer, a film, a region, a plate, or the like is described as being “on” another portion, this includes not only a case in which the portion is “directly on” another portion but also a case in which still another portion is present between the portion and another portion. Conversely, when a portion of a layer, a film, a region, a plate, or the like is described as being “under” another portion, this includes not only a case in which the portion is “directly under” another portion but also a case in which still another portion is present between the portion and another portion. In addition, in the present application, as being disposed “on” may include the case of being disposed not only on an upper portion but also on a lower portion.

In the present invention, a “vacuum double pipe” refers to a slurry transfer pipe configured to transfer an electrode slurry stored in a slurry tank to a slot die and refers to a structure including a first pipe and a second pipe. More specifically, in the present invention, the vacuum double pipe includes the first pipe fluidly connected to the slurry tank and the slot die, and the second pipe provided to be spaced apart from an outer wall (an outer peripheral surface) of the first pipe by a predetermined interval. In this case, a vacuum space is formed between the first pipe and the second pipe so that the slurry transfer pipe in the present invention may form a vacuum double pipe structure.

Meanwhile, the slurry transfer pipe of the present invention includes the vacuum space between the first pipe and the second pipe so that the electrode slurry transferred to a flow path of the first pipe may not be affected by an ambient temperature. Accordingly, when the electrode slurry stored in the slurry tank is transferred to the slot die, the device for coating an electrode slurry according to the present invention may keep a temperature of the electrode slurry constant.

Hereinafter, the device for coating an electrode slurry for a secondary battery according to the present invention and the method of coating an electrode slurry using the same will be described in detail with reference to the drawings.

### First Embodiment

According to a first embodiment of the present invention, a device for coating an electrode slurry for a secondary battery, which includes a slurry transfer pipe, is provided.

### Device for Coating an Electrode Slurry

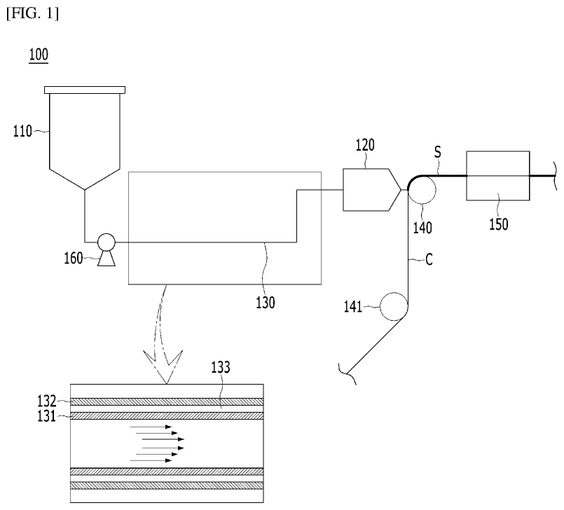

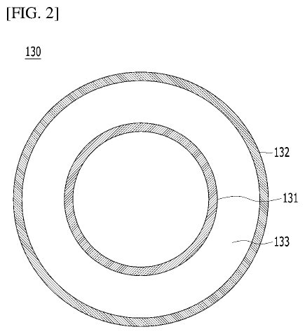

FIG. 1 is a schematic diagram illustrating a device for coating an electrode slurry for a secondary battery, which includes a slurry transfer pipe, according to the present invention, and FIG. 2 is a cross-sectional view illustrating the slurry transfer pipe.

Referring to FIGS. 1 and 2, the device 100 for coating an electrode slurry according to the present invention includes a slurry tank 110 configured to store an electrode slurry, a slot die 120 configured to discharge an electrode slurry S stored in the slurry tank 110 to a current collector C, and a slurry transfer pipe 130 configured to transfer the electrode slurry S stored in the slurry tank 110 to the slot die 120.

In this case, the slurry transfer pipe 130 has a vacuum double pipe structure including a first pipe 131 fluidly connected to the slurry tank 110 and the slot die 120, and a second pipe 132 provided to be spaced apart from an outer wall of the first pipe 131 by a predetermined interval and configured to form a vacuum space 133 between the first pipe 131 and the second pipe 132.

In the present invention, a “vacuum double pipe” refers to the slurry transfer pipe 130 configured to transfer the electrode slurry stored in the slurry tank 110 to the slot die 120 and refers to a structure including the first pipe 131 and the second pipe 132. More specifically, in the present invention, the vacuum double pipe includes the first pipe 131 fluidly connected to the slurry tank 110 and the slot die 120, and the second pipe 132 provided to be spaced apart from the outer wall (an outer peripheral surface) of the first pipe 131 by a predetermined interval. In this case, the vacuum space 133 is formed between the first pipe 131 and the second pipe 132 so that the slurry transfer pipe 130 forms a vacuum double pipe structure.

Meanwhile, the slurry transfer pipe 130 of the present invention includes the vacuum space 133 between the first pipe 131 and the second pipe 132 so that the electrode slurry S transferred to a flow path of the first pipe 131 may not be affected by an ambient temperature. Accordingly, when the electrode slurry S stored in the slurry tank 110 is transferred to the slot die 120, the device 100 for coating an electrode slurry according to the present invention may keep a temperature of the electrode slurry S constant.

Conventionally, in the process of applying the electrode slurry S to the current collector C, when the temperature of the electrode slurry S is higher than a set temperature, the electrode slurry S applied to the current collector C is densely applied in a central portion, and when the temperature of electrode slurry S is lower than the set temperature, the electrode slurry S is densely applied to both sides. Therefore, an amount of the electrode slurry S applied to the current collector C, that is, a height of the electrode slurry S applied to the current collector C, becomes non-uniform according to the temperature of the electrode slurry S so that there is a problem in that the electrode having a non-uniform rolling rate and a non-uniform rolling density is manufactured.

As described above, the present invention includes the slurry transfer pipe 130 having a dual structure formed of the first and second pipes 131 and 132 so that, when the electrode slurry S stored in the slurry tank 110 is transferred to the slot die 120, the temperature of the electrode slurry S may be kept constant. Accordingly, according to the present invention, the electrode slurry S is uniformly applied to the current collector C so that a defective rate in electrode manufacturing can be reduced.

The second pipe 132 of the slurry transfer pipe 130 is fixed to be spaced apart from an outer side of the first pipe 131 by a predetermined interval so that the vacuum space 133 is formed between the first pipe 131 and the second pipe 132.

In particular, an openable/closable air entrance opening (not shown) may be formed at one side of the second pipe 132. In particular, air inside the vacuum space 133 is discharged to the outside through the air entrance opening of the second pipe 132 using a separate vacuum pump and then the air entrance opening is sealed so that the vacuum space 133 may become in a vacuum state. In particular, after removing air remaining in a vacuum region through the air entrance opening, the air entrance opening is sealed so that a vacuum degree of the vacuum space 133 between the first and second pipes 131 and 132 may be increased.

The vacuum space 133 prevents the first pipe 131 from being directly exposed to the outside air and forms a vacuum layer between the outside air and the first pipe 131 so that a temperature of the first pipe 131 is less affected by an outside temperature to keep a temperature constant and thus a variation in temperature inside the first pipe 131 becomes small.

Meanwhile, although not shown in the drawings, a connection pipe fluidly connected to the vacuum region may be further included at the air entrance opening. In addition, the connection pipe may further include a check valve configured to allow the air inside the vacuum region to move in one direction. The check valve may discharge the air of the vacuum region to the outside so that the vacuum region becomes vacuum.

Here, the “being fluidly connected” means that pipes communicate with each other and may mean that the air entrance opening and the connection pipe are physically connected.

A structure of the slot die 120 is not particularly limited. For example, although not shown in the drawing, the slot die 120 may include a slit to which the electrode slurry transferred from the slurry transfer pipe 130 is supplied, and a discharge port configured to discharge the electrode slurry S passing through the slit toward the current collector C.

In addition, the slurry transfer pipe 130 may further include a feed pump 160 configured to supply the electrode slurry S stored in the slurry tank 110 to the slot die 120. The feed pump 160 may be connected to the slurry tank 110 to supply the electrode slurry S to the slot die 120. A supply amount of the electrode slurry S may be controlled according to the number of rotations of the feed pump 160.

In addition, the device 100 for coating an electrode slurry according to the present invention may further include a coating roll 140 configured to support and transfer the current collector C, and a drying chamber 150 configured to dry the electrode slurry S applied to the current collector C.

The drying chamber 150 may dry the current collector C coated with the electrode slurry S to complete an electrode plate. The current collector C is accommodated in the drying chamber 150 by a transfer device, and while passing through the drying chamber 150, the drying chamber 150 may be formed to have a length in which electrode slurry S can be completely dried.

The current collector C is supplied with constant tension by a guide roll 141. A metallic sheet, for example, known metal foil, may be generally used as the current collector C. Aluminum, nickel, or the like may be used as a positive electrode plate of the current collector C. Copper, nickel, a stainless steel, or the like may be used as a negative electrode plate of the current collector C. Preferably, aluminum foil may be used as a positive current collector, and copper foil may be used as a negative current collector.

In the device 100 for coating an electrode slurry according to the present invention, the slurry tank 110 may include a storage tank for storing an electrode slurry, a transfer tank, and a supply tank. In one example, the device 100 for coating an electrode slurry may supply a mixed electrode slurry from a mixer to the storage tank using a pump and supply the electrode slurry stored in the storage tank to the transfer tank. In addition, in order to coat the current collector with the electrode slurry transferred to the transfer tank, the device 100 may constantly feed the electrode slurry to the supply tank. Meanwhile, each tank may further include a temperature controller for controlling a temperature of the electrode slurry.

In this case, the tanks are fluidly connected to each other and may be connected by the above-described slurry transfer pipe 130. Accordingly, when the electrode slurry is transferred to the slot die 120, the temperature of the electrode slurry may be kept constant.

Due to the above structure, when the electrode slurry S stored in the slurry tank 110 is transferred to the slot die 120, the device 100 for coating an electrode slurry according to the present invention may keep a temperature of the electrode slurry S constant.

Accordingly, the device 100 for coating an electrode slurry according to the present invention may uniformly apply the electrode slurry S to the current collector C so that a defective rate in electrode manufacturing can be reduced.

### Second Embodiment

According to a second embodiment of the present invention, a device for coating an electrode slurry for a secondary battery, which includes a slurry transfer pipe, is provided.

### Device for Coating an Electrode Slurry

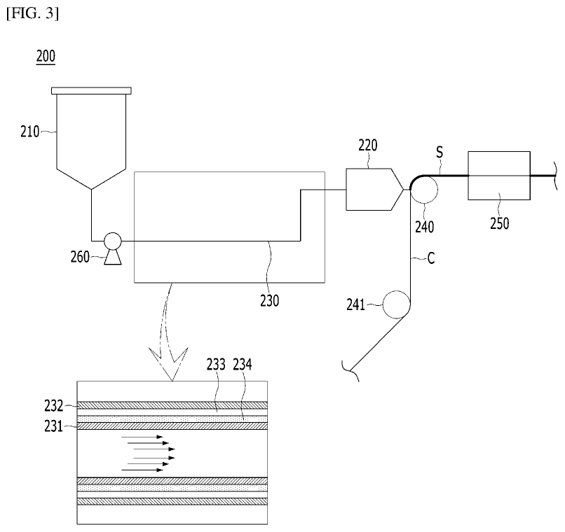

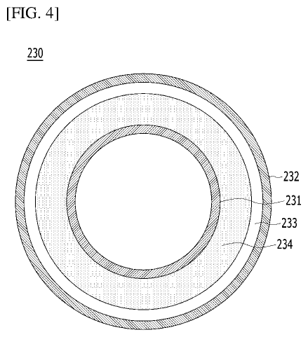

FIG. 3 is a schematic diagram illustrating a device for coating an electrode slurry for a secondary battery, which includes a slurry transfer pipe, according to the present invention, and FIG. 4 is a cross-sectional view illustrating the slurry transfer pipe.

Referring to FIGS. 3 and 4, a device 200 for coating an electrode slurry according to the present invention includes a slurry tank 210 configured to store an electrode slurry, a slot die 220 configured to discharge an electrode slurry S stored in the slurry tank 210 to a current collector C, and a slurry transfer pipe 230 configured to transfer the electrode slurry S stored in the slurry tank 210 to the slot die 220.

In this case, the slurry transfer pipe 230 has a vacuum double pipe structure including a first pipe 231 fluidly connected to the slurry tank 210 and the slot die 220, and a second pipe 232 provided to be spaced apart from an outer wall of the first pipe 231 by a predetermined interval and configured to form a vacuum space 233 between the first pipe 231 and the second pipe 232.

In the present invention, the vacuum space 233 prevents the first pipe 231 from being directly exposed to the outside air and forms a vacuum layer between the outside air and the first pipe 231 so that a temperature of the first pipe 231 is less affected by an outside temperature to keep a temperature constant and thus a variation in temperature inside the first pipe 231 becomes small.

In addition, the slurry transfer pipe 230 of the device 200 for coating an electrode slurry according to the present invention further includes an insulation member 234. More specifically, the slurry transfer pipe 230 may further include the insulation member 234 surrounding an outer circumferential surface of the first pipe 231.

The insulation member 234 may be made of a foam material and formed to surround the outer circumferential surface of the first pipe 231. The insulation member 234 may be formed of polyurethane foam.

Due to the above structure, when the electrode slurry S stored in the slurry tank 210 is transferred to the slot die 220, the device 200 for coating an electrode slurry according to the present invention may keep a temperature of the electrode slurry S constant.

Accordingly, the device 200 for coating an electrode slurry according to the present invention may uniformly apply the electrode slurry S to the current collector C so that a defective rate in electrode manufacturing can be reduced.

### Third Embodiment

According to a third embodiment of the present invention, a device for coating an electrode slurry for a secondary battery, which includes a slurry transfer pipe, is provided.

### Device for Coating an Electrode Slurry

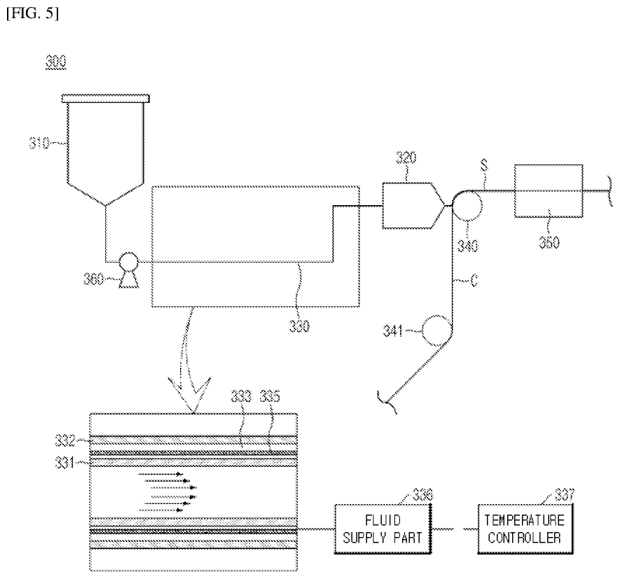

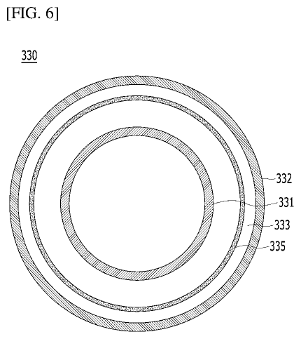

FIG. 5 is a schematic diagram illustrating a device for coating an electrode slurry for a secondary battery, which includes a slurry transfer pipe, according to the present invention, and FIG. 6 is a partial perspective view illustrating the slurry transfer pipe.

Referring to FIGS. 5 and 6, a device 300 for coating an electrode slurry according to the present invention includes a slurry tank 310 configured to store an electrode slurry, a slot die 320 configured to discharge an electrode slurry S stored in the slurry tank 310 to a current collector C, and a slurry transfer pipe 330 configured to transfer the electrode slurry S stored in the slurry tank 310 to the slot die 320.

In this case, the slurry transfer pipe 330 has a vacuum double pipe structure including a first pipe 331 fluidly connected to the slurry tank 310 and the slot die 320, and a second pipe 332 provided to be spaced apart from an outer wall of the first pipe 331 by a predetermined interval and configured to form a vacuum space 333 between the first pipe 331 and the second pipe 332.

In the present invention, the vacuum space 333 prevents the first pipe 331 from being directly exposed to the outside air and forms a vacuum layer between the outside air and the first pipe 331 so that a temperature of the first pipe 331 is less affected by an outside temperature to keep a temperature constant and thus a variation in temperature inside the first pipe 331 becomes small.

In the device 300 for coating an electrode slurry according to the present invention, the slurry transfer pipe 330 may include a third pipe 335 which is positioned between the first pipe 331 and the second pipe 332 and surrounds the first pipe 331. In addition, a structure in which a fluid is introduced between the first pipe 331 and the third pipe 335 may be provided.

In addition, the device 300 for coating an electrode slurry according to the present invention may further include a fluid supply part 336 fluidly connected to the third pipe 335 and configured to supply a fluid between the first pipe 331 and the third pipe 335, and a temperature controller 337 configured to control a temperature of the fluid supplied between the first pipe 331 and the third pipe 335.

The fluid supply part 336 may be a general fluid pump. Furthermore, although not shown in the drawings, a fluid control valve (not shown) may be included between the third pipe 335 and the fluid supply part 336 to control an amount of the fluid introduced between the first pipe 331 and the third pipe 335.

The temperature controller 337 may be a heater or a cooler, may detect the temperature of the electrode slurry transferred into the slot die 320 by attaching a temperature sensor to the slot die 320 to detect, and may easily control the temperature of the electrode slurry transferred into the slurry transfer pipe 330.

Meanwhile, although not shown in the drawings, the third pipe 335 and the fluid supply part 336 may be connected to each other to allow the fluid to circulate. For example, the third pipe 335 may have a structure in which a fluid inlet and a fluid outlet are formed, and the fluid supply part 336 may be fluidly connected to allow a fluid to circulate through the fluid inlet and the fluid outlet.

Meanwhile, the fluid introduced between the first pipe 331 and the third pipe 335 may be in a liquid or gel state. For example, the fluid may be a heat transfer fluid or may be water. In a specific embodiment, by filling a heat transfer fluid or water between the first pipe 331 and the third pipe 335, the temperature of the electrode slurry transferred into the first pipe 331 may be kept constant. The first pipe may be a thermally conductive metal pipe.

In particular, the temperature controller 337 may control the temperature of the fluid introduced between the first pipe 331 and the third pipe 335 in the range of 20° C. to 30° C. and in the range of 21° C. to 28° C., 23° C. to 27° C., or 24° C. to 26° C. For example, the temperature of the fluid may be controlled at an average temperature of 25° C. The temperature controller 337 may control a temperature of the fluid between the first pipe 331 and the third pipe 335, thereby controlling the temperature of the electrode slurry S to be transferred in the first pipe 331. In particular, when the temperature of the electrode slurry S is too high, the electrode slurry S applied to the current collector C may be densely applied in a center portion, and when the temperature of the electrode slurry S is too low, the electrode slurry S applied to the current collector C may be applied and concentrated to both sides. Therefore, the temperature of the electrode slurry may be controlled in the range of 20° C. to 30° C.

In addition, the device 300 for coating an electrode slurry according to the present invention may further include a temperature sensor (not shown). More specifically, the temperature sensor may be included in the slot die. For example, the slot die 320 may further include a temperature sensor configured to measure the temperature of the electrode slurry which is transferred into the slot die 320 or discharged from the slot die.

When the temperature of the electrode slurry measured by the temperature sensor is out of the range of 20° C. to 25° C., a temperature of a fluid may be controlled using the temperature controller 337.

Due to the above structure, when the electrode slurry S stored in the slurry tank 310 is transferred to the slot die 320, the device 300 for coating an electrode slurry according to the present invention may keep a temperature of the electrode slurry S constant.

Accordingly, the device 300 for coating an electrode slurry according to the present invention may uniformly apply the electrode slurry S to the current collector C so that a defective rate in electrode manufacturing can be reduced.

### Fourth Embodiment

According to a fourth embodiment of the present invention, a method of coating an electrode slurry using the device for coating an electrode slurry is provided.

### Method of Coating an Electrode Slurry

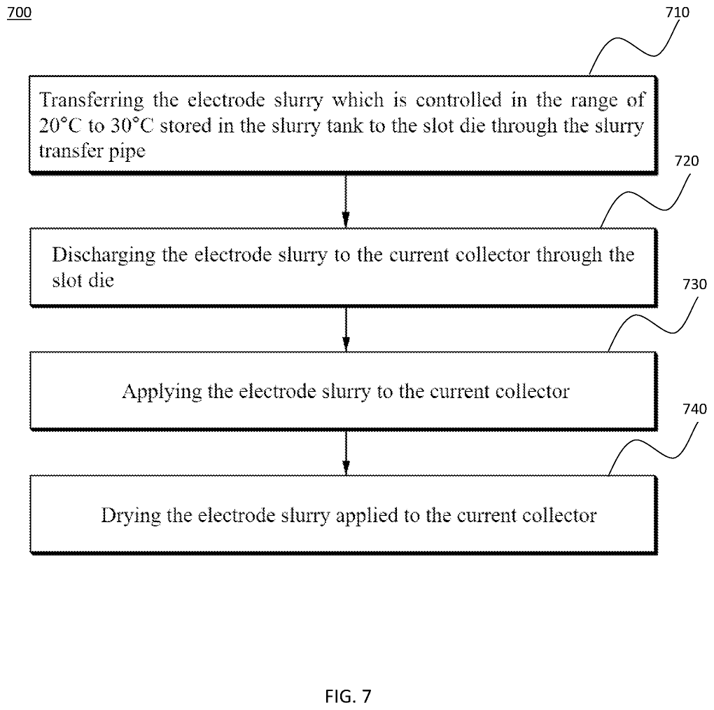

According to the present invention, referring to FIG. 7, the method 700 of coating an electrode slurry using the device for coating an electrode slurry is provided. In a specific example, the method of coating an electrode slurry according to the present invention includes, at 720, discharging the electrode slurry to the current collector moving in a coating direction MD through the slot die and, at 730, applying the electrode slurry to the current collector, and, at 740, drying the electrode slurry applied to the current collector.

In this case, in the applying of the electrode slurry, when heights of the electrode slurry applied to the current collector correspond to a central portion and a peripheral portion on both sides of the central portion based on a width direction TD, a difference in thickness between the central portion and the peripheral portion may be less than or equal to 5%. This means that, when the electrode slurry S stored in the slurry tank is transferred to the slot die, the temperature of the electrode slurry S is kept constant.

In a specific example, the applying of the electrode slurry includes, at 710, transferring the electrode slurry stored in the slurry tank to the slot die through the slurry transfer pipe, and in the transferring of the electrode slurry, the temperature of the electrode slurry may be controlled in the range of 20° C. to 30° C. and in the range of 21° C. to 28° C., 23° C. to 27° C., or 24° C. to 26° C.

For example, the temperature of the electrode slurry may be controlled at an average temperature of 25° C. The temperature controller 337 may control a temperature of the fluid, thereby controlling the temperature of the electrode slurry S to be transferred in the first pipe 331. In particular, when the temperature of the electrode slurry S is too high, the electrode slurry S applied to the current collector C may be densely applied to a center portion, and when the temperature of the electrode slurry S is too low, the electrode slurry S applied to the current collector C may be densely applied to both sides. Therefore, the temperature of the electrode slurry may be controlled in the range of 20° C. to 30° C.

The method of coating an electrode slurry according to the present invention uses the above-described device for coating an electrode slurry, and when the electrode slurry stored in the slurry tank is transferred to the slot die, the temperature of the electrode slurry may be kept constant.

Accordingly, the method of coating an electrode slurry according to the present invention may uniformly apply the electrode slurry S to the current collector C so that a defective rate in electrode manufacturing can be reduced.

As described above, the present invention has been described in more detail with reference to the accompanying drawings and the embodiments. Therefore, the configurations described herein or shown in the drawings are merely one embodiment of the present invention and do not represent all the technical spirit of the present invention such that it should be understood that there may be various equivalents and modifications capable of substituting the embodiments and the configurations at the time of filing the present application.

### DESCRIPTION OF REFERENCE NUMERALS

S: electrode slurry
C: current collector
100, 200, and 300: devices for coating an electrode slurry
110, 210, and 310: slurry tanks
120, 220, and 320: slot dies
130, 230, and 330: slurry transfer pipes
131, 231, and 331: first pipes
132, 232, and 332: second pipes
133, 233, and 333: vacuum spaces
234: insulation member
335: third pipe
336: fluid supply part
337: temperature controller
140, 240, and 340: coating rolls
150, 250, and 350: drying chambers
160, 260, and 360: feed pumps

1. A device for coating an electrode slurry, comprising:
a slurry tank configured to store an electrode slurry;
a slot die configured to discharge the electrode slurry stored in the slurry tank to a current collector; and
a slurry transfer pipe configured to transfer the electrode slurry stored in the slurry tank to the slot die,
wherein the slurry transfer pipe has a structure comprising:
a first pipe fluidly connected to the slurry tank and the slot die; and
a second pipe spaced apart from an outer wall of the first pipe by a predetermined interval and forming a vacuum space between the first pipe and the second pipe in an operational stage.

2. The device of claim 1, wherein the slurry transfer pipe further includes an insulation member surrounding an outer circumferential surface of the first pipe.

3. The device of claim 1, wherein:
the slurry transfer pipe includes a third pipe located between the first pipe and the second pipe and surrounding the first pipe; and has a structure in which a fluid is configured to be introduced between the first pipe and the third pipe.

4. The device of claim 3, further comprising:
a fluid supply part fluidly connected to the third pipe and configured to supply a fluid between the first pipe and the third pipe; and
a temperature controller configured to control a temperature of the fluid supplied between the first pipe and the third pipe.

5. The device of claim 4, wherein the temperature controller is configured to control a temperature of the fluid introduced between the first pipe and the third pipe in the range of 20° C. to 30° C.

6. The device of claim 3, wherein the slot die further includes a temperature sensor configured to measure the temperature of the slurry transferred into the slot die or discharged from the slot die.

7. The device of claim 1, wherein the second pipe has a structure having an openable/disclosable air entrance opening formed on one side of the second pipe.

8. The device of claim 1, further comprising:
a coating roll configured to support and transfer the current collector; and
a drying chamber configured to dry the electrode slurry discharged to the current collector.

9. The device of claim 1, wherein the slurry transfer pipe further includes a feed pump configured to supply the electrode slurry stored in the slurry tank to the slot die.

10. A method of coating an electrode slurry using the device for coating an electrode slurry according to claim 1, the method comprising:
discharging the electrode slurry to the current collector moving in a coating direction (MD) through the slot die and applying the electrode slurry to the current collector; and
drying the electrode slurry applied to the current collector,
wherein, in the applying of the electrode slurry, when heights of the electrode slurry applied to the current collector correspond to a central portion and a peripheral portion on both sides of the central portion based on a width direction (TD), a difference in thickness between the central portion and the peripheral portion is less than or equal to 5%.

11. The method of claim 10, wherein:
the applying of the electrode slurry includes transferring the electrode slurry stored in the slurry tank to the slot die through the slurry transfer pipe; and
in the transferring of the electrode slurry to the slot die, a temperature of the electrode slurry is controlled in the range of 20° C. to 30° C.
